(19) United States
(12) Patent Application Publication
(10) Pub. No.: US 2012/0288343 A1
(43) Pub. Date: Nov. 15, 2012

(54) MACHINING APPARATUS FOR LONG TUBE LENGTHS AND RELATED METHODS

(75) Inventor: Daniel H. Symonds, Houston, TX (US)

(73) Assignee: Smith International, Inc., Houston, TX (US)

(21) Appl. No.: 13/467,911

(22) Filed: May 9, 2012

Related U.S. Application Data
(60) Provisional application No. 61/484,011, filed on May 9, 2011.

(51) Int. Cl. B23D 41/04; B23D 37/00; B23D 43/00; B23D 37/04

(52) U.S. Cl. 409/244; 409/287; 409/249; 409/276

(57) ABSTRACT

An apparatus for machining a profile in an inner wall of a tubular includes a frame on which a drive system is disposed, a carriage head disposed on at least one track of the frame, wherein the drive system is configured to operate the carriage head along the at least one track, a torque tube coupled to the carriage head and extending therefrom, the torque tube having a cutting tool coupled thereto, and a plurality of stabilizer pads disposed proximate the cutting tool and along a circumference of the torque tube, wherein the plurality of stabilizer pads are configured to engage the inner wall of the tubular and centralize the cutting tool within the tubular.

### CROSS-REFERENCE TO RELATED APPLICATIONS

Pursuant to 35 U.S.C. §119(e), this application claims priority to U.S. Provisional Application No. 61/484,011, filed May 9, 2011, which is herein incorporated by reference in its entirety.

### BACKGROUND

1. Field of the Disclosure

Embodiments disclosed herein relate generally to an apparatus and methods for machining More specifically, embodiments disclosed herein relate to machining apparatuses for long tube lengths and related methods of operation.

2. Background Art

Machining apparatuses are typically used when precision machining is required, especially for odd shapes. Commonly machined surfaces include circular and non-circular holes, splines, and flat surfaces. Typical work pieces include small to medium sized castings, forgings, screw machine parts, and stampings. A commonly used tool for such machining is a broaching tool. Even though broaches can be expensive, machining is usually favorable to other processes when used for high-quantity production runs.

Broaching apparatuses are relatively simple as they only have to move the broach in a linear motion at a predetermined speed and provide a means for handling the broach automatically. Most machines are hydraulic, but a few specialty machines are mechanically driven. The machines are distinguished by whether their motion is horizontal or vertical. The choice of machine is primarily dictated by the stroke required.

Vertical broaching tools may be used for push broaching, pull-down broaching, pull-up broaching, or surface broaching. Push broaching tools are similar to an arbor press with a guided ram; typical capacities may be 5 to 50 tons. Horizontal broaching tools may be used for pull broaching, surface broaching, continuous broaching, and rotary broaching. Pull style broaching tools are basically vertical machines laid on the side with a longer stroke, in which a cutting tool is drawn through the work piece multiple times, incrementally removing material with each pass. In contrast, surface style broaching tools hold the broach stationary while the work pieces make multiple passes over the broach, as the work pieces are clamped into fixtures that are mounted on a conveyor system.

Current broaching tools are usually limited in the length of their stroke, and thus, limited in the length of work piece they are able to broach. The stroke length limitation is mainly due to the uncontrollability of radial forces for very long stroke lengths, which leads to imprecise cuts in the work piece. Accordingly, there exists a need for a machining apparatus capable of machining high precision finished profiles into longer length tubes.

### SUMMARY OF THE DISCLOSURE

In one aspect, embodiments disclosed herein relate to an apparatus for machining a profile in an inner wall of a tube, the apparatus including a frame on which a drive system is disposed, a carriage head disposed on at least one track of the frame, wherein the drive system is configured to operate the carriage head along the at least one track, a torque tube coupled to the carriage head and extending therefrom, a cutting tool coupled to an end of the torque tube, and a plurality of stabilizer pads disposed proximate the cutting tool and along at least a portion of a circumference of the torque tube, wherein the plurality of stabilizer pads are configured to engage the inner wall of a metal tube and centralize the cutting tool within the metal tube.

In other aspects, embodiments disclosed herein relate to a cutting tool, the cutting tool including a cutting head including an adjustable cutter block and a cutting element disposed on the cutter block, wherein a height of the cutter block is adjustable to a specified cut depth. The cutting tool further includes a stabilizer body disposed proximate the cutting head, the stabilizer body including a fixed stabilizer pad located opposite the cutting element and a first hydraulically actuated floating stabilizer pad, wherein the fixed stabilizer and the first floating stabilizer pad are configured to centralize the cutting head within a tubular.

In other aspects, embodiments disclosed herein relate to a method of machining a profile into an inner wall of a tube, the method including providing a cutting tool within a tubular, and making a plurality of progressively cut layers in the profile, wherein making each of the plurality of progressively cut layers includes cutting a plurality of cuts at a specified working surface depth.

Other aspects and advantages of the invention will be apparent from the following description and the appended claims.

### BRIEF DESCRIPTION OF DRAWINGS

FIG. 1 shows a perspective view of a machining tool in accordance with one or more embodiments of the present disclosure.

FIG. 2 shows a perspective view of a carriage head of the machining tool in accordance with one or more embodiments of the present disclosure.

FIG. 3 shows a perspective view of a cutting head and stabilizer of the machining tool in accordance with one or more embodiments of the present disclosure.

FIGS. 4A-4D show perspective views of components of the cutting head in accordance with one or more embodiments of the present disclosure.

FIG. 5A shows a cross-section view of the stabilizer in accordance with one or more embodiments of the present disclosure.

FIGS. 5B and 5C show cutaway perspective views of the stabilizer in accordance with one or more embodiments of the present disclosure.

FIG. 6 shows a cross-section view of the machining tool within a tubular in accordance with one or more embodiments of the present disclosure.

FIG. 7 shows a cross-section of a plurality of cuts in progressively cut layers in accordance with one or more embodiments of the present disclosure.

### DETAILED DESCRIPTION

In one aspect, embodiments disclosed herein relate to a machining apparatus for long tube lengths and related methods of operation. The machining apparatus is capable of controlling radial and lateral forces (i.e., reaction forces) generated during the machining operation, which allows the machining apparatus to maintain a high level of precision when machining longer tube lengths. Because of the controllability of the reaction forces, any length of tube may be machined using a machining apparatus in accordance with embodiments disclosed herein to machine any type of unique profile on an inner wall of a tube.

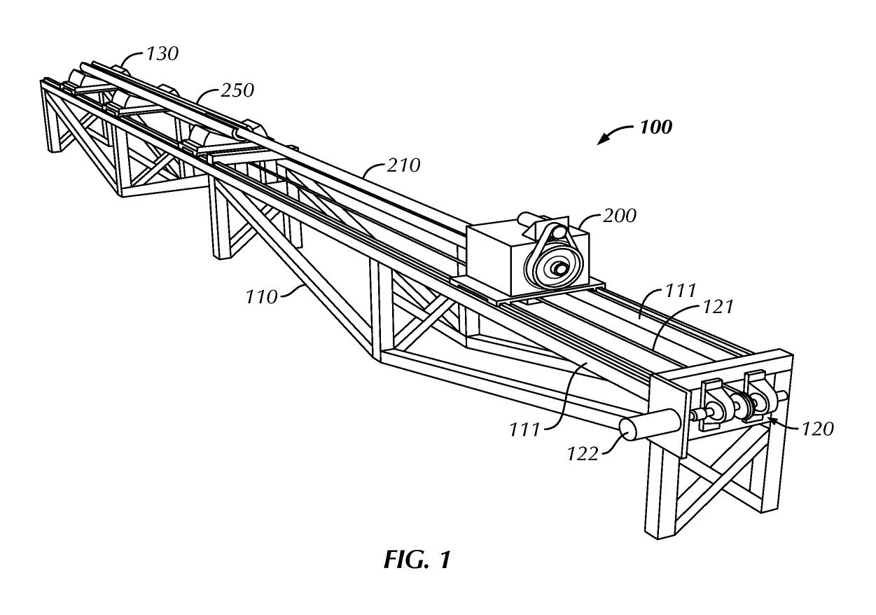

Referring now to FIG. 1, a perspective view of a machining apparatus 100 in accordance with embodiments of the present disclosure is shown. The machining apparatus 100 includes a frame structure 110 on which components of the machining apparatus 100 are mounted. The frame structure 110 may be constructed as a weldment, the size of which may vary depending on the length of tubulars to be cut by the machining apparatus. The frame structure 110 is configured to absorb compressive loads generated during cutting operations as well as rotary and lateral forces created by the cutting tool. The frame structure 110 may include any number or variety of active or passive damping devices configured to absorb compressive loads and rotary and lateral forces, such as dashpots.

Referring to FIGS. 1 and 2 together, the machining apparatus includes a carriage head 200 mounted on linear bearing rails or tracks 111 of the frame structure 110. There may be multiple tracks or only a single track on which the carriage head may translate. The carriage head 200 is configured to be drawn along the tracks 111 by a draw works drive system 120. The draw works drive system 120 includes a drive chain 121 connected to the carriage head 200 and a motor 122 to power the draw works drive system 120. In certain embodiments, the motor 122 may be an orbital hydraulic motor. For example, a 29,000 oz/inch orbital drive hydraulic motor operated between 0 and 160 revolutions per minute may be used. The motor 122 may provide up to about 6,000 pounds of draw force in certain embodiments. However, those skilled in the art will understand an array of other types of motors may be used to drive the draw works system 120. In other embodiments, the draw works drive system 120 may use a rack and pinion mounted down a center of the frame structure 110 with the rack (not shown) oriented with the teeth on the side. The pinion (not shown) may be vertically mounted on the carriage head 200 and engage the rack. The pinion may be driven be a servo drive (not shown) through a precision gear head.

A linear scale feedback system (not shown) may be included (e.g., mounted on the frame or carriage head) to provide substantially instantaneous feedback as to the position of the carriage head 200 at different locations along the tracks 111. Those skilled in the art will understand that any type of device relying on electrical current to convey a position or distance may be used in accordance with embodiments disclosed herein. Referring to FIG. 2, a perspective view of the carriage head 200 is shown. The carriage head 200 includes bearings 208 configured to allow a torque tube 210 (FIG. 1), which extends therefrom, to rotate. Rotation of the torque tube 210 is powered and controlled by a servo motor 206 mounted on the carriage head 200 through a gear chain or strap 204 coupled to a sprocket 202 in line with the torque tube 210, as shown in FIG. 2. The servo motor 206 may be driven by a main computer numerically controlled (“CNC”) control unit (not shown) and may be programmable in angular position and rotational speed by the CNC control unit.

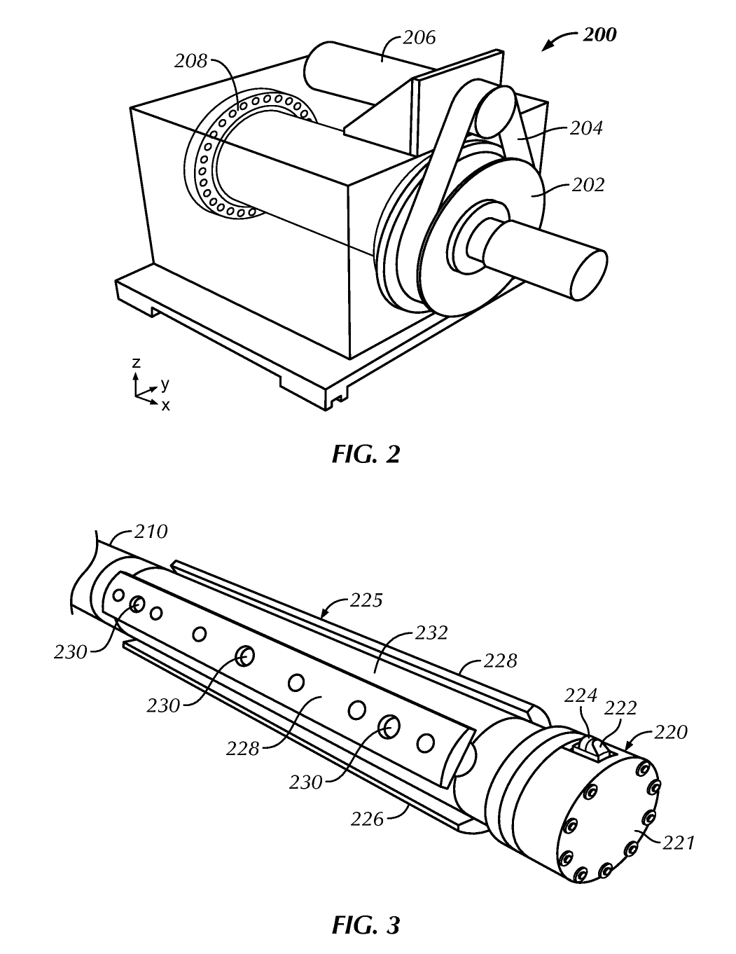

A CNC control unit may be employed to provide automatic, precise, and consistent motion control of the carriage head 200 and cutting head 220 (FIG. 3) during machining operations. All forms of CNC equipment have two or more directions of motion, called axes. These axes may be precisely and automatically positioned along their lengths of travel. The two most common axis types are linear (i.e., driven along a straight path) and rotary (i.e., driven along a circular path). CNC machines allow motions to be controlled through programmed commands. Generally speaking, the motion type (e.g., rapid, linear, and circular), the axes to move, the amount of motion and the motion rate (i.e., feedrate) are programmable with almost all CNC machine tools.

Accurate positioning is accomplished by a CNC command executed within the control (commonly through a program), which instructs the drive motor to rotate a precise number of times. A feedback device allows the control to confirm that the commanded number of rotations has taken place. All CNC controls allow axis motion to be commanded using coordinate systems, which typically include either a rectangular coordinate system or a polar coordinate system. In rectangular coordinate systems, each linear axis of the machine tool can be thought of as like a base line of a graph. Like graph base lines, axes are broken into increments. Instead of being broken into increments of conceptual ideas like time and productivity, each linear axis of a CNC machine's rectangular coordinate system is broken into increments of measurement. In the inch mode, the smallest increment is usually 0.0001 inch, while in the metric mode the smallest increment is commonly 0.001 millimeter, although other increment sizes are possible. Rotary axes increments are usually 0.001 degrees.

For CNC purposes, an origin point, or the starting point of each axis, is commonly called the program zero point (also called work zero, part zero, and program origin). For this example, the two axes described may be labeled as X and Y but those skilled in the art will understand that program zero can be applied to any axis. In addition, those skilled in the art will understand that the names of each axes may change from one CNC machine type to another (other common names include Z, A, B, C, U, V, and W). The program zero point establishes the point of reference for motion commands in a CNC program. This allows the programmer to specify movements from a common location. For example, with this technique, if the programmer wishes the tool to be sent to a position one inch to the right of the program zero point, X1.0 is commanded. If the programmer wishes the tool to move to a position one inch above the program zero point, Y1.0 is commanded. The control will automatically determine how many times to rotate each axis drive motor and ball screw to make the axis reach the commanded destination point.

Almost all current CNC controls use a word address format for programming, although those skilled in the art will be familiar with alternatives. Word address format merely means that the CNC program receives commands in sentence-like format. Each command is made up of CNC words. Each CNC word has a letter address and a numerical value. The letter address (e.g., X, Y, Z, etc.) tells the control the kind of word and the numerical value tells the control the value of the word. Used like words and sentences in the English language, words in a CNC command tell the CNC machine what it is the operator wishes the machine to do at the present time. The CNC programmer must know the programmable motion directions (axes) available for the CNC machine tool. The axes names may vary from one machine tool type to the next. The axes are always referred to with a letter address. Common axis names are X, Y, Z, U, V, and W for linear axes and A, C, and C for rotary axes.

As previously discussed, whenever a programmer wishes to command movement in one or more axes, the letter address corresponding to the moving axes as well as the destination in each axis are specified. X3.5, for example tells the carriage head to move the X axis to a position of 3.5 inches from the program zero point in X (assuming the absolute mode of programming is used). In general, the three most common motion types of a CNC machine include rapid motion, straight line motion, and circular motion. These motion types share two things in common. First, they are all modal, which means they remain in effect until changed. Second, the end point of the motion is specified in each motion command. The current position of the machine will be taken as the starting point.

Rapid motion (also called positioning), is used to command motion at the carriage head's fastest possible rate. It is used to minimize non-productive time during the machining cycle. Common uses for rapid motion include positioning the carriage head to and from cutting positions, moving to clear clamps and other obstructions, and in general, any non-cutting motion during the program. For example, as used herein with the machining apparatus, rapid motion may be employed for a non-cutting stroke of the carriage head, which will be described in more detail subsequently. Straight line motion allows the programmer to command perfectly straight line movements allows the programmer to specify the motion rate (feedrate) to be used during the movement. Straight line motion may be used any time a straight cutting movement is required, including when drilling, turning a straight diameter, face or taper, and when milling straight surfaces. The method by which feedrate is programmed varies from one machine type to the next. Circular motion causes the cutting tool to make movements in the form of a circular path (i.e., this motion type may often be used to generate radii during machining) All feedrate related points discussed above regarding straight line motion may still apply. Additionally, circular motion requires that, by one means or another, the programmer specifies the radius of the arc to be generated. Thus, a combination of straight line motion and circular motion may be employed during a cutting stroke of the carriage head of embodiments disclosed herein.

As previously described, the CNC control will execute a CNC program in sequential order exactly as it is written. All commands necessary to make the machine do the required operations must be included in the CNC program in the proper order. For machines that have the ability to perform operations with one or more tools, there are four kinds of program format: program start-up format, tool ending format, tool start-up format, and program ending format. The programmer may begin every program with program start-up format. At the completion of program start-up format, the tool may be ready to begin cutting. At this point, the programmer may program the cutting operations with the first tool. When finished cutting, the programmer may follow the format to end the tool (tool ending format). The programmer may then toggle among cutting information, tool ending format and tool start-up format until the finished cutting with the last tool. At this point, the programmer may follow the format to end the program. While a number of CNC control concepts are disclosed herein, one of ordinary skill in the art will be familiar with variations in procedures, formatting, programming, and other variables of CNC machining that may be used in accordance with embodiments disclosed herein.

Machining apparatus 100 further includes a clamping structure 130 that is configured to secure a tubular 250 (i.e., the work piece) on the frame and in place for machining The clamping structure 130 may include one or more of any types of vises, clamps, or other fastening devices known to those skilled in the art to secure the tubular 250 in place. The clamping device 130 may include one or more individual clamps or fastening devices arranged in a variety of different manners (i.e., individual clamps positioned at different locations along the length of the tubular 250). The individual clamps of the clamping structure 130 are substantially aligned with a centerline of a main torque tube 210 (described below), which allows the clamping structure 130 to act as a centralizing fixture and locate the tubular 250 on a centerline of a main torque tube 210. Additionally, the clamping structure 130 absorbs linear and rotational reaction loads from the cutting tool (not shown) as the cutting tool is drawn down the length of the tubular 250 and may include any number of damping devices.

As previously described, the machining apparatus 100 includes a torque tube 210 that is attached to and extends from the carriage head 200. The torque tube 210 may be coupled with the carriage head 200 through a spline connection (not shown), which allows the torque tube 210 to be interchangeable. The spline connection, as used herein, may include a plurality of axial splines arranged circumferentially on an end of the torque tube 210. For example, the torque tube 210 may have external splines configured to engage internal splines of the carriage head, or vice versa. In other embodiments, the torque tube 210 may be fastened to the carriage head 200 with mechanical fasteners or similar fastening devices. Alternatively, the spline connection may have helical splines.

Further, the torque tube 210 may have one or more centralizers or cradles (not shown) disposed along a length thereof to prevent “drooping” along a length of the torque tube. Stated otherwise, the one or more centralizers may be provided for radial support along an axial length of the torque tube 210 to keep the torque tube 210 substantially straight along a length thereof. For example, the centralizers may include, in certain embodiments, bushings to allow the torque tube 210 to rotate within the centralizers. The bushings may be formed from nylon, brass, or other materials known in the art. In other embodiments, there may be a “v-block” or other similar device at one end of the tubular and outside the machining apparatus 100 for support.

As described above, the torque tube is configured to rotate as cuts are made in an inner wall of a tubular 250. Various torque tubes having different stiffnesses may be used accordingly as required for a particular cut, as will be understood by those skilled in the art. In certain embodiments, the torque tube 210 may have a length of between about 5 and 25 feet. In other embodiments, the torque tube 210 may have a length of greater than 25 feet. The length of the torque tube 210 may dictate a stroke length of the machining apparatus 100.

The torque tube 210 has a cutting head 220 and a stabilizer 225 disposed on an end thereof. In certain embodiments, the cutting head 220 may be disposed on a distal end of the torque tube (i.e., the cutting head 220 is on an end of the torque tube 210 opposite from the carriage head 200) as shown in FIG. 3 in accordance with embodiments of the present disclosure. The cutting head 200 may be coupled to an end of the torque tube 210 through a spline connection, which allows the cutting head 220 to be interchangeable. Likewise, the stabilizer 225 may be coupled to the torque tube 210 through a spline connection. Interchangeability of the various components of the machining apparatus allows for fast replacement of individual components without requiring the entire machine to be disassembled. In alternate embodiments, the cutting head 220 may be disposed at any location along a length of the torque tube. The cutting head 220 includes a cutter block 222 secured therein by an end cap 221, the cutter block 222 having a cutting element 224 attached thereto.

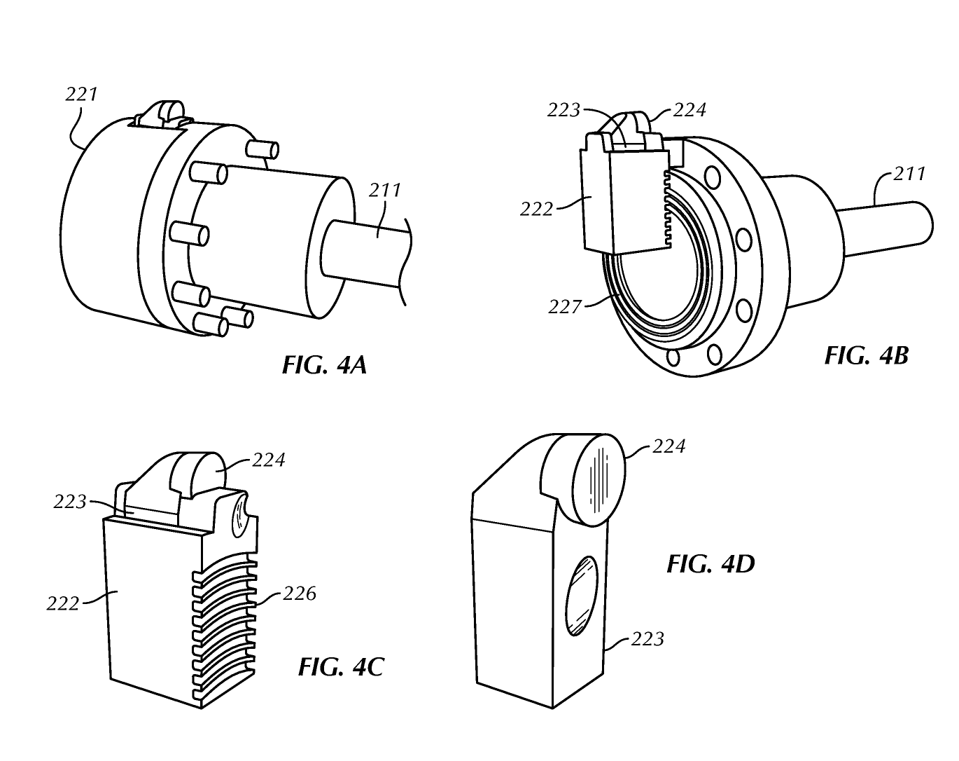

Referring briefly to FIGS. 4A-4D, perspective views of components of the cutting head 220 in accordance with embodiments of the present disclosure are shown. Cutting head 220 includes a cutter block 222 having grooves or teeth 226 (FIG. 4C) configured to engage corresponding grooves or teeth of a scroll plate 227 (FIG. 4B). The cutter block 222 is restricted to vertical movement in a channel formed between the scroll plate 227 and the end cap 221 (FIG. 3) secured on a distal end of the cutter head 220. Because of the engagement or meshing of the corresponding teeth on the cutter block 222 and scroll plate 227, rotation of the scroll plate 227 may increase or decrease a height of the cutter block 222. For example, rotating the scroll plate 227 in a first direction may increase a height of the cutter block 222, while rotating the scroll plate 227 in a second, or opposite direction, may decrease a height of the cutter block 222. Because a cutting element 224 is attached to the cutter block 222, rotation of the scroll plate 227 likewise increases or decreases a height of the cutting element 224, which ultimately allows a desired cutting element height for a particular cut depth to be set. As used herein, unless specified otherwise, the term “cut depth” or “depth of cut” means the maximum depth of tube material removed by the cutting element for a given cut.

The scroll plate 227 may be rotated by a second torque tube 211 (shown in FIG. 4A) disposed within torque tube 210, and which extends from the carriage head 200 to the scroll plate 227. The second torque tube 211 is rotated relative to the torque tube 210 and may be controlled by a second servo motor disposed on the carriage head 200, and which is driven by the main CNC control unit. In certain embodiments, the scroll plate 227 may be rotated while the cutting head 220 is in operation (i.e., as the cutting head 220 is drawn through the tube, for example a stator tubular), thereby allowing a groove having a variable depth along an axial length of a tube to be cut. In still further embodiments, alternative adjustment mechanisms may be used for adjusting a cutter height including, but not limited to, tapered wedges, cone wedges, hydraulic or mechanical screw mechanisms, cam and follower mechanisms, and other adjustment mechanisms known to those skilled in the art.

Finally, as shown in FIG. 4D, a removable cutter cartridge 223, which is secured in the cutter block 222 (with for example, a set screw), and on which the cutting element 224 is attached, allows for quick replacement of the cutting element 224 as required. The cutting element 224 is positioned such that the cutting element 224 is capable of engaging and cutting a surface of the tubular. For example, when the cutting element is generally cylindrical, the upper face of the cutting element 224 is positioned transverse to the cutting direction. Cutting element 224 may be selected from a number of known cutting elements, including but not limited to, high speed steel or alloy steel, diamond (e.g., polycrystalline diamond compact (PDC) cutters), tungsten carbide and other materials known to those skilled in the art. Further, various coatings may be applied to the cutting elements, including, but not limited to a titanium nitride coating and ceramic coatings, which may be applied on the cutting element to prolong life or reduce wear of the cutting element 224. Those skilled in the art will understand alternative cutting element materials may be used. Likewise, while the cutting element is shown as arcuate or circular (cylindrical), other non- circular (cylindrical) cutting element shapes may be employed, including, but not limited to, triangular, quadrangular, elliptical or oval-shaped, and other cutting element profiles known to those skilled in the art.

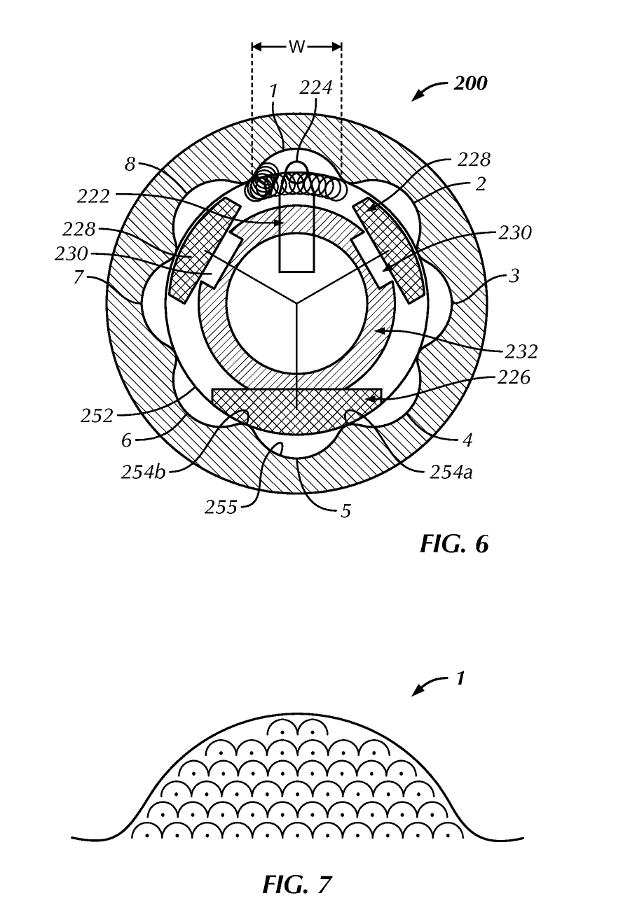

Further, a cutting element size may vary for various lobe profiles that are machined in a tube. A cutting element diameter may be selected as a specified percentage of a finished profile width (i.e., a profile to be cut in the inner wall of the tube) (shown in and described fully with reference to FIG. 6). As used herein, a finished profile width “W” may be measured across the finished lobe profile from apex to apex (as shown in FIG. 6). Other profile shapes may be similarly measured. For example, in certain embodiments, a cutting element diameter may be selected to be between about 1% and 25% of the working surface. In other embodiments, the cutting element diameter may be selected to be between about 5% and about 15% of the working surface width. In other embodiments, the cutting element diameter may be selected to be between about 1% and about 25% of the finished profile width, suitably between about 5% and about 15% of the finished profile width. For example, smaller diameter cutting elements may be used initially when cutting commences, followed by increased diameter cutting elements as cutting nears completion for surface finishing of the lobe profile.

In alternate embodiments, the cutting head 220 may include other types of machining tools, including, but not limited to, milling cutters, grinding tools, and other machining tools adapted to the cutting head as known to those skilled in the art. One or more motors, which may be electric or hydraulic, may be disposed adjacent the particular machining tool to provide power. The one or more motors may be coupled to the machining tools and connected within the torque tube or other component of the machining apparatus.

Referring back to FIG. 3, the stabilizer 225 includes one or more stabilizer pads 226 and 228 attached or coupled thereto and arranged about a portion of the circumference of the stabilizer 225. In certain embodiments, the stabilizer pads may be manufactured with hardened ground tool steel having a carbide surface thereon. Other materials may include, but are not limited to, brass or carburized tool steel. The stabilizer pads may have a generally convex arcuate outer surface that is configured to contact an inner wall of the tubular. In certain embodiments, the outer arcuate surface of the stabilizer pads may be substantially parallel with a corresponding arc length of the tube inner wall. Stated otherwise, the outer arcuate surface of the stabilizer pads may be substantially concentric with the corresponding arc length of the tube inner wall. In alternate embodiments, the arcuate outer surface of the stabilizer pads may be mismatched with a corresponding arc length of the tube inner wall. In still further embodiments, the outer surface of the stabilizers may be flat, concave, angled, or other surface geometries understood by those skilled in the art. The stabilizer pads 226 and 228 may have an axial length of between 1 foot and 5 feet in certain embodiments. In other embodiments, the stabilizer pads may have an axial length of between about 1.5 feet and about 2.5 feet. In certain embodiments, all of the stabilizer pads may have equal lengths. In other embodiments, all of the stabilizer pads may have unequal lengths, or two or more stabilizer pads may have equal lengths, which are unequal to any remaining stabilizer pad lengths.

At least one of the stabilizer pads may be a fixed stabilizer pad 226 positioned substantially 180 degrees opposite from the cutting element 224. As used herein, a fixed stabilizer pad is set at a particular height and is non-extendable for height adjustments. The fixed stabilizer 226 may be attached to the stabilizer body 232 by any number of known fasteners. The fixed stabilizer pad 226 may be configured to contact an inner wall of a tubular and absorb reaction forces generated by the cutting element 224 during the machining process. In alternate embodiments, more than one fixed stabilizer pad may be used and spaced equally with respect to the cutting element 224.

The stabilizer 225 further includes one or more floating or adjustable stabilizer pads 228 coupled thereto, which are configured to be adjusted to centralize the cutting head 220 within the tubular 250 (FIG. 1) (i.e., align a central axis of the cutting head 220 with a central axis of the tubular 250). In embodiments with more than one floating stabilizer pad 228, the floating stabilizer pads 228 may have equal lengths in certain embodiments, or unequal lengths in others. Still further, the one or more floating stabilizer pads 228 may have lengths equal to the fixed stabilizer pad length, or alternatively, floating stabilizer lengths unequal to the fixed stabilizer pad length.

As used herein, floating stabilizer pads may mean that the stabilizer pad is radially adjustable or extendable in height either hydraulically or mechanically. Floating stabilizer pads 228 are coupled to pistons 230, which are sealingly disposed and translatable within cylinders 229 formed in the body of the stabilizer 225. The pistons 230 are configured to be hydraulically actuated and translated within the cylinders 229 to extend radially outward. The floating stabilizer pads 228 are forced into contact with the inner wall of the tubular 250, which aids in absorbing radial and lateral forces generated by the cutting head 220. In certain embodiments, a single large floating stabilizer pad (not shown) may contact the inner wall of the tubular on both sides of the cutting head 250. For example, the single large stabilizer pad may have a middle region in which the cutting head 220 is located. The stabilizer pad may be formed such that although it is a single pad it provides at least two contact points against the inner wall of the tubular, which stabilizes the cutting head within the tubular. Likewise, reducing the hydraulic pressure allows the pistons 230 to radially retract within the cylinders 229 and retract the floating stabilizer pads 228 from contact with the inner wall of the tubular 250.

In certain embodiments, two floating stabilizer pads 228 and the fixed stabilizer pad 226 may be located 120 degrees apart, as measured from the centerline of the stabilizer pads. In alternate embodiments, more than two floating stabilizer pads may be disposed on the stabilizer and spaced equally around a portion of the circumference of the stabilizer body 232. In still further embodiments, one or more floating stabilizer pads 228 may be spaced unequally about a circumference of the stabilizer body 232. It should be understood that any number of stabilizer pads may be used in accordance with embodiments disclosed herein. In alternate embodiments, a floating or adjustable stabilizer may be disposed opposite from a fixed cutting head (in which the cutting element is disposed), the cutting head being fixed at a particular height while the stabilizer may be adjustable to define a cutting height. Further, in additional embodiments, one or more adjustable stabilizers may be disposed about the stabilizer body 232 to adjust a cutting height of a fixed cutting head. In still further embodiments, all stabilizer pads may be floating or adjustable.

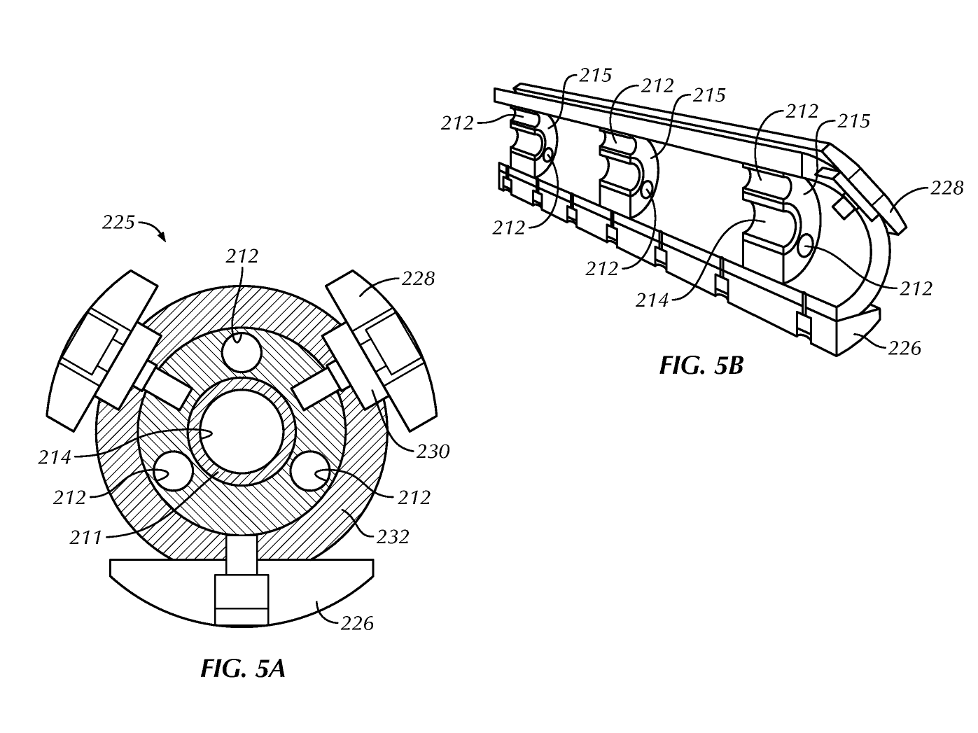

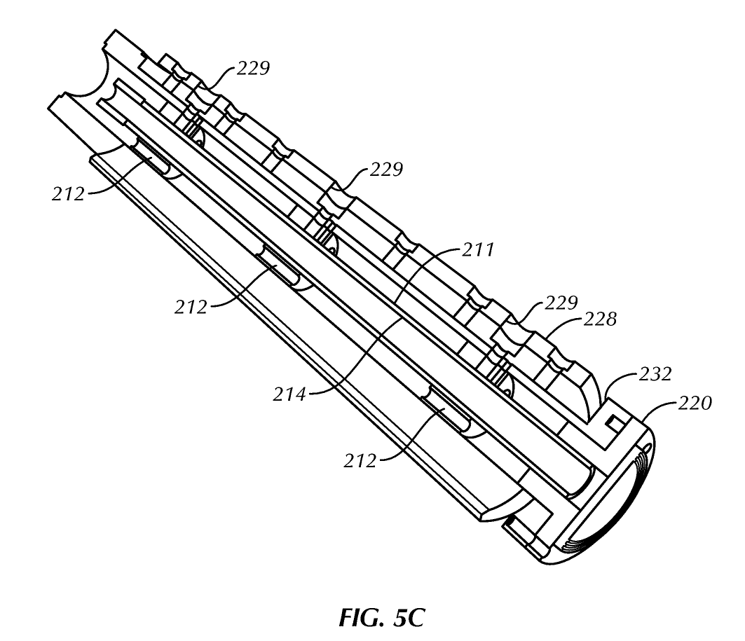

Referring now to FIGS. 5A-5C, cross-section and cutaway perspective views of the stabilizer 225 in accordance with embodiments of the present disclosure are shown. Floating stabilizer pads 228 and fixed stabilizer pad 226 are shown coupled to a stabilizer body 232. While FIG. 5 shows a stabilizer having two floating stabilizer pads and one fixed stabilizer pad, one of ordinary skill in the art will appreciate that the number and positions of the stabilizer pads may vary based on a given application or profile to be machined as discussed above. One or more collars 215 are included and spaced along an axial length within the stabilizer body 232 and have outer fluid channels 212 therethrough, the outer fluid channels 212 extending an entire length of the stabilizer body 232 and torque tube 210 (FIG. 3). Outer fluid channels 212 are configured to carry coolant from a pressurized fluid system (not shown) through the torque tube 210 (FIG. 3), through the stabilizer body 232 and collars 215 to flush and lubricate the cutting tool as it is drawn through the tubular. A filtration system (not shown) may be used in conjunction with the pressurized coolant system to screen used fluid.

At least one of the outer fluid channels 212 may be in fluid communication with a small hydraulic passage (not shown) formed through the scroll plate 227 (FIG. 4B) through which pressurized fluid is able to flow and lubricate the entire cutting head 220 (FIG. 4A). The machining apparatus, therefore, may be self lubricating. In addition, the pressurized fluid may build against a back face of the scroll plate 227 (FIG. 4B), which urges the scroll plate 227 slightly in the direction of the cutter block 222. In addition, the end cap 221 (FIG. 4A) is fastened on a distal end of the cutting head 220 and acts against the cutter block 222 in the opposite direction. As such, because of the opposing forces provided by the end cap 221 on one side of the cutter block 222 and the pressurized fluid acting against the scroll plate 227 on the other side of the cutter block 222, the cutter block is securely clamped and locked in placed between the two, much like a vise. This locking or clamping effect further prevents the scroll plate 227 from rotating, which helps maintain the cutting element at a constant cut depth for more precise machining

Referring still to FIGS. 5A-5C, a central fluid channel 214 extending through the second torque tube 211 (also described in reference to FIG. 4A) carries fluid from a pressurized coolant system to hydraulically actuate the pistons 230 coupled with the floating stabilizer pads 228. Fluid flowing through the central fluid channel 214 is configured to communicate through cylinders 229 and actuate the pistons 230 to extend the pistons along with the floating stabilizer pads 228. The torque tube 211 may have apertures (not shown) in a wall thereof to allow fluid communication from within the central fluid channel 214 radially outward to the individual cylinders 229. The fluid may travel outward through the chambers and into an annular cavity (not shown) formed within the collars 215 around the torque tube 211. From the annular cavity, the fluid may flow into cylinders 229 to actuate pistons 230. In certain embodiments, the same pressure source may be used to supply pressurized fluid to both the outer fluid channels 212 and the central fluid channel 214. In alternate embodiments, separate fluid sources may be used to supply the central fluid channel 214 and the outer fluid channels 212.

The fluid from the pressurized fluid system may be routed to flow through the separate channels 212, 214 prior to entering the torque tube so that the fluid pressure through each channel may be maintained independently. For example, the fluid pressure in the outer fluid channels 212 (for flushing and lubricating the cutting head) may be maintained at full pressure (e.g., within a range of about 275 psi to about 325 psi, or beyond). The fluid pressure in the central fluid channel 214 (for hydraulic actuation of floating stabilizer pads 228) may be fluctuated within a broader range as required (e.g., within a range of about 15 psi to about 325 psi, or beyond).

Fluid pressure in the central fluid channel 214 may be adjusted to tune the machining apparatus as needed by the operator, for example to adjust to a desired cut depth, to adjust to different tubular (i.e., work piece) diameters, or to eliminate chatter during machining In certain embodiments, the pressurized fluid system may include a pressure compensating valve to allow pressure to bleed off as the stabilizer pads adapt to undulations in an inner profile of a stator tube or other tubular. The pressure compensating valve may maintain a relatively constant pressure head in the pressurized fluid system. For example, the pressurized fluid system may be set at a constant pressure. If the stabilizer pads are compressed due to a smaller diameter undulation in the tubular, the pressure compensating valve allows fluid pressure to bleed off and maintain the constant set pressure. Likewise, in a larger diameter section of the tubular, the pressure compensating valve may allow fluid pressure to build within the pressurized fluid system to maintain the constant set pressure. In addition, the fluid pressure in the pressurized fluid system may be automatically adjusted by a computer program tied in with the CNC machine and receiving signals from various sensors near or in the stabilizer pads. In other embodiments, the operator may manually adjust the fluid pressure of individual stabilizer pads or all of the stabilizer pads.

Referring now to FIGS. 1-7 together, machining methods generally include drawing and rotating the cutting head through the tubular and making a plurality of cuts at the same working surface depth (i.e., cuts made in the inner working surface of the tubular which working surfaces are at substantially equal radial distances from a centerline of the tubular) in a plurality of progressively cut layers to form a profile into an inner wall of a tubular. The plurality of cuts in progressively cut layers of a first profile 1 is illustrated in FIG. 7. As used herein, “progressive” refers to series of cuts made at increasingly greater radial distances from a centerline of the tubular as a profile is cut into the inner wall. Those skilled in the art will understand that any number of progressively cut layers may be required to complete a profile. In alternate embodiments, the tubular may be rotated while a non-rotating cutting head is drawn through the tubular to make a plurality of cuts in an inner surface of the tubular. In still further embodiments, a non-rotating cutting head may remain stationary while a rotating tubular is drawn over the non-rotating cutting head to make a plurality of cuts in an inner surface of the tubular.

FIG. 6 shows a cross-section view of at least a portion of the machining apparatus 100 within the tubular 250 for machining in accordance with embodiments of the present disclosure. After the tubular 250 is aligned with the torque tube 210 and secured within clamping structure 130, the floating stabilizer pads 228 and the cutter block 222 are retracted (by rotating scroll plate 227) as the torque tube 210 (with cutting head 220 and stabilizer 225) is extended through the tubular 250, also known as a non-cutting return stroke. When the torque tube 210 is fully extended through an entire length of the tubular 250, a desired first cut depth is set (by adjusting the cutter block 222 height) and the cutting element 224 is positioned at an initial starting point.

Initially, the cutting element 224 is positioned at a starting point of a first profile 1 (FIG. 6), the floating stabilizer pads 228 are actuated and extended radially outward to engage an inner wall of the tubular 250. The fixed stabilizer pad 226 engages the inner wall of the tubular 250. The equally spaced stabilizer pads 226, 228 engage the inner wall and work to centralize the cutting head 220 within the tubular 250. The stabilizer pads 226, 228 are configured having a width and arc length long enough to bridge across at least two lobes 254 (i.e., apexes) on each side of a valley 255 into the inner wall 252 of the tubular 250. Thus, in certain embodiments, the size of the stabilizer pads may be varied or selected based on the profile to be machined such that the stabilizer pads will contact at least a portion of an uncut portion of the inner wall on either side of the finished lobe profile. The valleys 255 and lobes 254 are representative of a profile machined in the inner wall of the tubular; however, those skilled in the art will understand numerous alternative profiles that may be cut in the inner wall of the tubular 250. Thus, the stabilizer pads 226, 228 may be able to adequately centralize the cutting head within the tube because the stabilizer pads 226, 228 are always engaged with a uniform minor diameter 252 of the inner wall of the tubular 250.

To initiate cutting a first series of cuts at a first cut depth, the cutting head 220 is rotated as it is drawn back through a full length of the tubular 250 to cut a helix or other profile in the inner wall for the first profile 1, also known as the cutting stroke. After a first pass through the tubular 250, the cutter block 222 and the floating stabilizer pads 228 are again retracted and the torque tube is extended back through the tubular 250. Before making a second cut at the same cut depth, the cutting element 224 is positioned at a starting point for a second cut. In other embodiments, the height of the cutting element 224 may be adjusted to a different cut depth from the first cut depending on the type of profile desired by the operator. When the cutting element 224 is in position at the appropriate cut depth and start point, the floating stabilizer pads 228 are again extended to contact the inner wall of the tubular 250, and the torque tube 210 is rotated at the same speed as the first cutting stroke while it is drawn back through the tubular 250 on the second cutting stroke. Subsequently, the cutter block 222 and floating stabilizer pads 228 are again retracted and the torque tube is extended back through the tubular 250 to begin a third cut.

The plurality of cuts in each progressively cut layer may be carried out in any number of patterns until the particular layer is complete. For example, in one embodiment, individual cuts may be made on each profile spaced around the circumference of the tube, after which a subsequent series (second series) of cuts may be made at the first cut depth for each profile in sequential order around the circumference of the tubular 250 in the same manner as the first series of cuts. Thus, all profiles would be cut concurrently and essentially completed at the same time. In other embodiments, a single profile at time may be cut, and the cut patterns used may vary. For example, in one embodiment, after the first cuts are made on one side of a centerline of the profile, a subsequent cut may be made on an opposite side of the centerline of the same lobe profile. This process may continue, alternating to either side of the centerline with each pass and eventually meeting at the centerline of the finished lobe profile to complete a cut layer. In other embodiments, the cuts may begin substantially at the centerline and move away from the centerline with each pass. Still further, adjacent cuts may be made for each level of cut depths across the profile, starting at one side of the finished profile and working across the finished profile to the other side. In this example, subsequent series of cuts may begin substantially directly adjacent to the prior cut. In certain embodiments, the second series of cuts may overlap the first series of cuts by a certain amount, leaving a stepover between the first and second series of cuts. After the second series of cuts has been made in all profiles spaced around a circumference of the tubular, a third series of cuts may be made in each of the profiles. This process may continue until a desired number of series of cuts at the first cut depth are completed.

To begin series of cuts at a second cut depth (i.e., second cut layer), the cutter block 222 may be adjusted such that a height of the cutting element is set to a second cut depth. Multiple cutting strokes may be performed sequentially about the circumference of the inner wall of the tubular 250 as previously described to complete multiple series of cuts at the second cut depth. Still further, additional levels of cuts (i.e., third, fourth, fifth, etc) at correspondingly increasing cut depths may be completed using the same process. The cutting strokes may continue until a finished profile is machined into the inner wall of the tubular 250. Those skilled in the art will appreciate that while eight separate profiles are shown cut into the inner wall of the tubular 250, any number of profiles may be cut in accordance with one or more embodiments disclosed herein. In certain embodiments, the cutting stroke may be performed at a rate of between about 400 and 800 inches per minute, while the return stroke may be performed at a rate of between about 1000 and 1400 inches per minute. Those skilled in the art will understand that the cutting and return strokes may be varied according to profile geometries, tube material properties, cutting element properties, and other factors known to those skilled in the art.

FIG. 6 shows finished profiles (e.g., numbered 1-8) in an inner wall (having a minor diameter 252) of the tubular 250. As previously described, the cutting head is drawn through the tubular 250 to remove material from the inner wall of the tubular 250 by a machining form of cutting action. The tool is rotated at a prescribed rate during the cutting pass to generate a spiral track down the length of the tubular. The cutting action is repeated with the cutting head being repositioned to a new cutting position for each pass until the desired profile is created. Passes by the machining apparatus through the tubular 250 may be CNC programmed for a single lobe valley 255 from tangent point 254a to tangent point 254b of the minor diameter 252 and executed as a subroutine. The CNC programming also controls incremental cut depths as they are made to form the profile, as well as the rotation speed of the cutting head as it is drawn through the tubular.

In other embodiments, a first level of multiple adjacent cuts may be made for a first lobe profile. The multiple adjacent cuts in the first level may be separated or spaced by a specific stepover of distance between the centers of the multiple cuts. Depending on the surface finish desired, the stepover may be varied to obtain a rougher or smoother surface finish. For example, a larger stepover may yield a smoother surface finish. The first level of multiple adjacent cuts may be followed by a second level of multiple adjacent cuts, followed by a third level of multiple adjacent cuts, and so on. In this embodiment, an entire lobe profile may be completed before moving around the circumference of the tube to begin cutting subsequent lobe profiles. In still other embodiments, one or more levels of cuts may be made in multiple lobe profiles cut around the circumference in any number of various sequences as will be determined and understood by those skilled in the art.

Multiple profile configurations may be cut into the tube using embodiments of the present disclosure. In certain embodiments, a helix configuration may be cut along the length of the tube. In other embodiments, a non-helical longitudinal groove may be cut along the length of the tube. The longitudinal groove may be configured to house electrical wires or hydraulic lines down the length of the tube (e.g., a stator tube) to provide electrical or hydraulic communication to a tool disposed on an end thereof. Still further, pockets or grooves may be cut in the tube in which sensors or other devices may be disposed to provide communication between downhole components and the surface (e.g., Smart Bit™ technology, measurement-while-drilling (“MWD”) equipment, logging-while-drilling (“LWD”) equipment, and other downhole sensors and/or data collection equipment known to those skilled in the art).

Further, a surface finish of the multiple profiles may be determined by the cutter sizes used during the cutting strokes. The surface finish of the inner wall of the tubular may be controlled by an amount of overlap between adjacent cuts. The amount of overlap between adjacent cuts may determine a cusp height or stepover between each cut. In turn, the cusp height may determine the surface finish of the cut profile. As used herein, the surface finished may be measured perpendicular to a longitudinal axis of the cut (i.e., “cross-grain”). A larger overlap between adjacent cuts may produce a smoother finish, while less overlap between adjacent cuts may produce a rougher finish. In certain embodiments, a surface finish or roughness of the profiles may be about 500. In other embodiments, a surface finish or roughness of the profiles may be between about 32 and 500. Furthermore, multiple cutter sizes in various sequences may be used to control a surface finish of the profile. For example, a number of cutting strokes may be made using a first cutter size, followed by a number of cutting strokes made by a second cutter size for a smoother surface finish. In certain embodiments, the surface finish of the profiles may be specified to be an optimum bonding surface finish for a particular rubber used within a stator tube.

Advantageously, embodiments of the present disclosure provide a machining apparatus or machining apparatus capable of managing radial and lateral forces (reaction forces) created during machining at the cutting head itself, which provides improved control of the cutting element. Providing a stabilizer at or proximate the cutting head removes limitations as to a tube length that may be machined (i.e., any length of tube may be machined). Thus, the machining apparatus is capable of machining tubes having lengths of 25 feet or greater without sacrificing high precision cuts associated with machining operations.

Embodiments of the present disclosure may reference a tubular; however, it is intended within the scope of the present disclosure that any metal tube may be used. The tubular may be a steel tube or other metallic tube. In certain embodiments, the profile may be machined into a metal inner wall (surface) of the tubular. In other embodiments, the tubular may include a housing (for example a metal housing) with an inner wall (surface) onto which a liner may be disposed thereon. The liner may be machined using the machining apparatus described herein. Liner materials may include, but are not limited to, fiberglass, epoxy, rubber, polyphenylene sulphide (PPS), polyaryletherketones (PEEK), and plastics. Liner materials may also include other metallic materials such as aluminum, copper, silver, low-temperature alloys, silver-tin-bismuth compounds, and others. The machined profile may form a finished surface configured to final dimensions or may form an intermediate surface of the tubular. In certain embodiments, a substantially even (uniform) wall (layer) of rubber (elastomeric material) may be disposed on (bonded to) the intermediate machined surface which may form the finished surface configured to final dimensions. In other embodiments, a non-uniform wall (layer) of rubber (elastomeric material) may be disposed on (bonded to) the intermediate machined surface which may form the finished surface configured to final dimensions.

In addition, embodiments disclosed herein use a single fluid source, the pressurized coolant system, to hydraulically actuate the stabilizer pads, which increases the efficiency of the machine. Embodiments disclosed herein may reduce the amounts of hazardous or detrimental byproducts that may be commonly associated with alternative machining processes such as electro-chemical machining (“ECM”). Still further, embodiments disclosed herein may provide a machining apparatus that is capable of machining various profiles and tube sizes without requiring significant tooling changes to do so, which ultimately reduces machining lead times.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. An apparatus for machining a profile in an inner wall of a tubular, the apparatus comprising:
a frame on which a drive system is disposed;
a carriage head disposed on at least one track of the frame, wherein the drive system is configured to operate the carriage head along the at least one track;
a torque tube coupled to the carriage head and extending therefrom;
a cutting tool coupled to an end of the torque tube; and
a plurality of stabilizer pads disposed proximate the cutting tool and along at least a portion of a circumference of the torque tube;
wherein the plurality of stabilizer pads are configured to engage the inner wall of the tubular and centralize the cutting tool within the tubular.

2. The apparatus of claim 1, further comprising a rotary drive system disposed on the carriage and configured to rotate the torque tube.

3. The apparatus of claim 1, wherein the plurality of stabilizers comprises at least one fixed stabilizer pad and at least one floating stabilizer pad.

4. The apparatus of claim 3, wherein the at least one floating stabilizer pad is coupled to a piston and is hydraulically actuated to engage the inner wall of the tubular.

5. The apparatus of claim 4, wherein the fluid to hydraulically actuate the at least one floating stabilizer pad is diverted from a coolant system.

6. The apparatus of claim 1, wherein each of the plurality of stabilizer pads has a width configured to bridge at least two lobes of a finished lobe profile cut in the inner wall of the tubular.

7. The apparatus of claim 1, wherein a length of the torque tube is at least 25 feet.

8. The apparatus of claim 1, further comprising a CNC control unit configured to control a cut depth of the cutting tool and a rotation of the torque tube during cutting.

9. The apparatus of claim 1, further comprising a clamping structure attached to the frame and configured to secure the tubular and position the tubular about a centerline of the torque tube.

10. The apparatus of claim 1, further comprising a coolant system configured to force coolant through the torque tube to lubricate the cutting tool and to flush debris.

11. A cutting tool comprising:
a cutting head comprising:
an adjustable cutter block; and
a cutting element disposed on the cutter block,
wherein a height of the cutter block is adjustable to a specified cut depth; and
a stabilizer body disposed proximate the cutting head, the stabilizer body comprising:
a fixed stabilizer pad located opposite the cutting element; and
a first hydraulically actuated floating stabilizer pad;
wherein the fixed stabilizer and the first hydraulically actuated floating stabilizer pad are configured to centralize the cutting head within a tubular.

12. The cutting tool of claim 11, further comprising:
a second hydraulically actuated floating stabilizer pad,
wherein a centerline of the first floating stabilizer pad, a centerline of the second floating stabilizer pad, and a centerline of the fixed stabilizer pad are located about 120 degrees apart.

13. The cutting tool of claim 12, further comprising pistons disposed in the stabilizer body that correspond to the first floating stabilizer pad and the second floating stabilizer pad, wherein the pistons are configured to extend and force the first and second floating stabilizer pads into contact with an inner wall of the tubular.

14. The cutting tool of claim 12, further comprising fluid passages formed in the stabilizer body through which coolant is routed to hydraulically actuate the first and second floating stabilizer pads.

15. The cutting tool of claim 11, wherein a cutting element diameter is between about 1% and about 25% of a finished profile width.

16. The cutting tool of claim 11, wherein a cutting element diameter is between about 5% and about 15% of a finished profile width.

17. A method of machining a profile into an inner wall of a tubular, the method comprising:
providing a cutting tool within a tubular; and
making a plurality of progressively cut layers in the profile,
wherein making each of the plurality of progressively cut layers includes cutting a plurality of cuts at a specified working surface depth.

18. The method of claim 17, further comprising centralizing the cutting tool within the tubular with at least one stabilizer pad.

19. The method of claim 17, further comprising providing a stepover between the plurality of cuts at the specified working surface depth for a specific lobe profile surface finish.

20. The method of claim 17, further comprising providing a cutting tool including a cutting element having a diameter between about 1% and about 25% of a finished lobe profile width.

21. The method of claim 17, further comprising providing a cutting tool including a cutting element having a diameter between about 5% and about 15% of a finished lobe profile width.

22. The method of claim 17, further comprising varying the specified working surface depth in two or more of the plurality of progressively cut layers.

23. The method of claim 17, wherein at least one of said plurality of cuts at a specified working surface depth is offset from a centerline of said profile.

24. The method of claim 23, wherein a first plurality of said cuts are offset to one side of the centerline of said profile and a second plurality of said cuts are offset to an opposite side of the centerline of said profile.

25. The method of claim 23, wherein at least half of the volume of at least one profile is formed using a cutting tool at the same cut depth.

26. The method of claim 25, wherein at least 80 percent of the volume of the at least one profile is formed using a cutting tool at the specified working surface depth.

27. The method of claim 26, wherein at least 90% of the volume of the at least one profile is formed using a cutting tool at the specified working surface depth.

28. The method of claim 17, wherein a plurality of cuts at a first working surface depth have the same specified working surface depth.

29. The method of claim 28, wherein a plurality of cuts at a second working surface depth have the same specified working surface depth.

30. The method of claim 29, wherein the specified working surface depth at the first working surface depth differs from the specified working surface depth at the second working surface depth.
